(19) United States
(12) Patent Application Publication
(10) Pub. No.: US 2016/0353747 A1
(43) Pub. Date: Dec. 8, 2016

(54) COMPOSITIONS AND METHODS FOR ACHIEVING A BIOLOGICAL EFFECT IN TARGET VEGETATION

(71) Applicant: Ento Bio LLC, Orange, OH (US)

(72) Inventors: Jeffrey T. Bargiel, Orange, OH (US); Keith D. Wing, Wilmington, DE (US)

(21) Appl. No.: 15/176,610

(22) Filed: Jun. 8, 2016

Related U.S. Application Data
(60) Provisional application No. 62/172,739, filed on Jun. 8, 2015.

(51) Int. Cl. A01N 63/04; A01N 57/20

(52) U.S. Cl. CPC A01N 63/04; A01N 57/20

(57) ABSTRACT

Compositions and methods are used to degrade; decay; kill; stunt; decompose; slow, stop, prevent growth or regrowth of; compost; wound; or break down vegetation or lignocellulosic material.

### RELATED APPLICATIONS

This patent application claims priority to Application Ser. No. 62/172,739 entitled “Methods to Abate Plant Wastes and Stumps” filed on Jun. 8, 2015 the entirety of which is incorporated by reference herein.

### GOVERNMENT FUNDING

This invention was made with government support under Award No. 1549677 awarded by the National Science Foundation of the United States government. The government has certain rights in the invention.

### FIELD OF THE INVENTION

The present invention relates generally to compositions and methods for achieving vegetation degradation.

### BACKGROUND

Billions of tons of unwanted vegetation and lignocellulosic material waste are created each year in residential, commercial, and agricultural settings Eliminating this waste is costly, time-intensive and labor-intensive. Existing methods of eliminating this waste have significant drawbacks. For example, traditional composting requires large space or facilities and has cycle times on the order of many months or years. Although chemical methods can involve less labor than other methods, they require long processing times to be effective and can also pose environmental and health risks.

Removal of unwanted tree stumps is particularly challenging. Grinding and digging are expensive, loud, labor-intensive, equipment-intensive, and disruptive to the landscape. Burning with or without accelerants such as kerosene is dangerous, can continue smoldering through the root system underground for weeks, and can put people and structures at risk.

There is also a need for preventing new or existing growth of vegetation. Examples of such a need include: preventing the spread of disease, slowing or killing the growth of invasive plants, preventing the resprouting of undesirable plants, and discouraging undesired growth in pruned plants. Living unwanted vegetation is often killed or stunted with synthetic herbicides or plant growth regulator hormones. Both are hazardous for the safety of employees and the environment and carry heavy regulatory burdens for significant users, such as those involved in vegetation management along roads, railroads, pipeline, and power lines. It is therefore desirable to eliminate or limit the use of synthetic herbicides and plant growth regulator hormones.

Others have attempted to develop alternative and safer methods for degrading target vegetation using enzyme-producing microorganisms or biodegradable depolymerase enzymes such as cellulases, hemicellulases, esterases, pectinases, lipases, and cutinases. However, previous compositions using depolymerase enzymes require large amounts of depolymerase enzymes to be effective. See, for example, European Patent No. 184,288.

### DEFINITIONS

“Agricultural additive” is a substance that can be used to enhance, alter, enable, or improve the performance of an agricultural chemical, bioactive agent, enzyme, protein, or other substance used to achieve vegetation degradation. Examples include, without limitation, one or more of the following substances: carriers, adjuvants, surface active agents, humectants, stickers, preservatives, dyes, yeast extracts, saccharides, and cofactors.

“Bioactive agent” is a substance that causes or aids in causing vegetation degradation, including, without limitation, one or more of the following agents: biocide, herbicides, pesticides, insecticides, fungicides, acaricides, composting accelerants, microorganisms, and plant growth regulators.

“Vegetation degradation,” as used herein, means to degrade; decay; kill; stunt; decompose; slow, stop, prevent growth or regrowth of; compost; wound; or break down all or a portion of the target vegetation.

“Depolymerase” is an enzyme, peptide, or catalytically active domain capable of degrading a protecting or supporting component of the target vegetation.

“Non-depolymerase protein” is a non-polymer-degrading amino acid, peptide, polypeptide, protein, enzyme, or protein hydrolysate.

### SUMMARY OF THE INVENTION

The described embodiments relate to improved compositions and methods for degrading target vegetation.

In one embodiment, the composition comprises at least one depolymerase derived from a first organism and at least one non-depolymerase protein derived from a second different organism.

In another embodiment, the compositions comprises one or more depolymerases selected from the group: cellulases, hemicellulases, ligninases, polysaccharidases, pectinases, esterases, proteases.

In another embodiment, the composition comprises one or more non-depolymerase proteins selected from the group: non-polymer-degrading enzymes, non-catalytic amino acids, peptides, polypeptides, proteins, enzymes, or protein hydrolysates.

In another embodiment, the composition comprises one or more depolymerases or non-depolymerase proteins selected or from derived from a xylophagous organism, such as a termite, including the termite Reticulhermes flavipes.

In yet another embodiment, the composition comprises one or more depolymerases or non-depolymerase proteins selected or derived from the fungus Trichoderma reesei or other filamentous fungi.

In yet another embodiment, the composition comprises one or more of the following: biocides, herbicides, pesticides, insecticides, fungicides, acaricides, plant growth regulators, microorganisms, or synthetic composting accelerants.

In one embodiment, the composition includes one or more of the following additives: carriers, adjuvants, surface active agents, humectants, preservatives, dyes, yeast extract, cofactors, stickers, saccharides, or mixtures thereof.

In another embodiment, at least one depolymerase or one non-depolymerase protein can be expressed from a recombinant expression vector or vectors of a recombinant expression system.

In another embodiment, the depolymerase and non-depolymerase protein are in one or more of the following forms: liquid, gel, pellet, film, spray, aerosol, or solid.

In yet another embodiment, the composition is applied to target vegetation in order to achieve vegetation degradation.

In another embodiment, the composition is sprayed, brushed, spread into or onto, fed through a slow- or continuous-release apparatus onto, or injected into the target vegetation.

In another embodiment, the composition is applied to the target vegetation in combination with drilling, wedging, shoveling, axing, grinding, chopping, smashing, pulverizing, cutting or any other method of mechanical preparation or disruption before, during, or after applying the composition.

In another embodiment, the composition is applied to a tree branch or stump after pruning or felling said tree to prevent or retard adventitious growth, such as epicormic sprouts.

In yet another embodiment, the amount of bioactive agent required to achieve vegetation degradation is reduced by applying the composition in combination with the bioactive agent to the target vegetation.

### DETAILED DESCRIPTION

The present discussion is a description of exemplary embodiments only and is not intended as limiting the broad aspects of the present disclosure.

The present disclosure is directed towards a composition for degrading, decaying; killing; stunting; decomposing; slowing, stopping, preventing growth or regrowth of; composting; wounding; or breaking down all or a portion of the target vegetation. Target vegetation includes any vegetation or lignocellulosic material that is either living or dead, including any parts or components thereof including, without limitation, sprouts, buds, trunks, branches, cambium, phloem, xylem, cork, and stumps. Target vegetation may be in the form of trees, flowering and non-flowering plants, bushes, seedlings, saplings, and seeds or fruit.

It is a surprising and advantageous finding of the present invention that the combination of one or more depolymerases and one or more non-depolymerase proteins exhibits a greater degrading effect than one or more depolymerases alone when applied to target vegetation. This is especially surprising because non-depolymerase proteins are not otherwise known to have direct activity towards the protective or supporting components of target vegetation. The function of the non-depolymerase protein will depend on the depolymerase in the composition. In some cases, the non-depolymerase protein will enhance the effectiveness of the depolymerase by occupying binding sites on either the depolymerase itself or the vegetation. In other cases, the non-depolymerase protein might produce a co-factor. In yet other cases, the non-depolymerase protein may occupy inhibitors.

This invention thus encompasses compositions and methods of use of said compositions to induce vegetation degradation by applying a mixture of at least one depolymerase and one non-depolymerase protein to the target vegetation. Selection of the depolymerase is based on the polymeric composition of the target vegetation. For example, the preferred depolymerases for Loblolly pine with a composition of 44% cellulose, 22% hemicellulose, and 27% lignin would include cellulase, hemicellulase, and ligninase. Other depolymerases may include, without limitation, carbohydrolase, pectinase, esterase, proteinase, cutinase, lipase or any other structural or lipid polymer-degrading enzyme capable of degrading the supporting or protective components of the target material such as cell walls, membranes, waxy or lipid layers, etc.

Depolymerases may include, without limitation: cellulases, hemicellulases, ligninases, polysaccharidases, pectinases, esterases, proteases. Cellulases may include, without limitation: glycoside hydrolases, beta-glucosidase, endoglucanase, exoglucanase, lytic polysaccharide monooxygenase, polysaccharide lyase, carboxymethyl cellulase, avicelase. Hemicellulases may include, but are not limited to: xylanase, mannanase, arabinase, galactanase. Ligninases may include such examples as: phenol oxidase, laccase, lignin peroxidase, versatile peroxidase, and manganese peroxidase. Esterases may include, without limitation lipase or cutinase. Other depolymerases may include: endo-glucanase Cell-1, exo-glucanase GHF7-3, beta-glucosidase β-glu1, esterase EST, laccase LacA or laccase LacB as generally described in U.S. Pat. No. 8,445,240; or endo-xylanase GHF11-1 as generally described in WO 2013/126230 A1.

One or more depolymerases or non-depolymerase proteins may also be expressed through one of numerous known methods in one or more recombinant expression vectors, including: bacterial cells such as Escherichia coli, or eukaryotic systems such as Saccharomyces cerevisiae, Pichia pastoris, filamentous fungus, baculovirus-infected cells, non-lytic insect cell expression, plant systems, or mammalian systems.

Non-depolymerase proteins may include, without limitation, any non-polymer-degrading peptide, polypeptide, or protein including enzymes such as: catechol oxidase, catalase, superoxide dismutase, aldo-keto reductase, glutathione peroxidase, or tannase and non-catalytic amino acids, peptides, polypeptides, proteins, or protein hydrolysates such as soy protein, corn protein, glutamate, or bovine serum albumin. Other non-depolymerase proteins may include: catalase CAT or aldo-keto reductase AKR as generally described in WO 2013/126230 A1; or superoxide dismutase SOD or glutathione peroxidase GPx1 as generally described in WO 2015/069308 A1.

Depolymerases and non-depolymerase proteins include those from microorganisms, insects, animals, or plants such as from the fungus Trichoderma reesei or xylophagous organisms such as the termite Reticulitermes flavipes. (Scharf, Kovaleva, Jadhao, Campbell, Buchman, & Boucias, 2010) (Scharf, et al., 2013) (Scharf, Karl, Sethi, & Boucias, 2011) (Scharf & Sethi, 2013) (Sethi, Slack, Kovaleva, Buchman, & Scharf, 2013).

It should be understood that in practicing this invention that particular combinations of depolymerase, non-depolymerase protein, application methods, and the optional addition of bioactive agents, agricultural chemicals and additives may not be effective towards all vegetation or lignocellulosic material. This selectivity is normal for biological control treatments and allows for the ability to target specific organisms or material while minimizing negative effects on non-target organisms. For instance, a combination of depolymerases and non-depolymerase proteins tailored to the degradation of a tree stump may have limited to no effect on surrounding vegetation which the user may want to leave intact.

Selecting the depolymerase and non-depolymerase protein from two different organisms is preferred as such selection will result in a broader spectrum of enzymatic activity than using a depolymerase and non-depolymerase from the same organism. Furthermore, it is advantageous to select the non-depolymerase from relatively inexpensive commercially available non-depolymerases, such as corn and soy protein, which are unlikely to be derived from the same sources as the depolymerase. The particular combination, application, dosage, and optimal conditions can readily be determined by those skilled in the art without undue experimentation by simple testing in laboratory, greenhouse, or field.

The ratio of depolymerase to non-depolymerase protein in the composition can vary based on numerous factors, including without limitation: the type of target vegetation, the type of effect sought, the form of the composition (liquid, pellet, gel, etc.), and whether other components are used in combination with the depolymerase and non-depolymerase protein. The ratio of depolymerase to non-depolymerase protein can be from about 100,000:1 to 1:1000.

The concentration of the depolymerase and non-depolymerase protein can vary based on the same factors stated above. For instance, relatively high concentrations may be required for compositions injected into tree stumps and relatively low concentrations may be required for compositions sprayed onto fields of vegetation. The total concentration of depolymerase and non-depolymerase protein may be equal to or less than 50% of the weight of the target vegetation, or less than 10%, or less than 1%, or less than 0.1%, or less than 0.01%, or less than 0.001%, or less than 0.0001%. The ratio of depolymerase to non-depolymerase protein may be equal to or greater than 1:1000, or greater than 1:100, or greater than 1:10, or greater than 1:1, or greater than 1:0.01, or greater than 1:0.0001, or greater than 1:0.00001.

The composition may also comprise a bioactive agent. Bioactive agents used in the composition are those that are already known to be useful for degrading vegetation or lignocellulosic material. The composition can decrease the amount of the bioactive agent required to achieve the desired vegetation degradation on the target vegetation. For example, the concentration of the bioactive agent may be reduced by greater than 20%, such as greater than 50%, or even greater than 80% when they are used in combination with the composition and have the same effect on the target vegetation when compared to using the compound alone. The composition may further comprise one or more agricultural additives to further enhance, modify, improve, or enable the performance of the composition.

Compositions for practice of the invention can be formulated in numerous ways, including flowables, dry flowables, water dispersible granules, emulsified concentrates, films, aerosols, sprays, substrate, or gels. The composition can be applied to the target vegetation by being sprayed, brushed, spread into or on to, fed through a slow- or continuous-release apparatus onto, or injected into the target vegetation. The target vegetation can also be covered or sealed to enhance the effect of the composition. The composition can also be applied to pockets, holes, channels, or girdled areas of the vegetation.

In the practice of this invention, the composition's components can be applied simultaneously or sequentially and, if sequentially, in different forms as necessary. The system can include various pre-, post-, or intermediate treatments such as grinding, chipping, drilling, wounding, scarring, or cutting. For example, a hole can be pre-drilled into a tree stump, first filled with cellulase granules then filled with liquid soy protein. The processing time for the composition varies depending on the nature of the target vegetation. For example, the composition may be effective on living vegetation in three days or less. The composition requires longer periods of time, weeks and potentially months, to be effective in tree stumps.

The present invention is further described by way of the following non-limiting examples.

### EXAMPLES

### Example 1

In one example, combinations of cellulase and hemicellulase from Trichoderma viride (i.e. depolymerase, labeled “Enz” in Table 1), bovine serum albumin (i.e. non-depolymerase protein, labeled “BSA” in Table 1), and glyphosate (labeled “Gly” in Table 1) are blended and applied in 2 mL doses directly to zinnia (Zinnia peruviana var. “Giant Dahlia”) seedlings at the first true leaf stage. Treatments ranged from 0-1.6 mg of depolymerase that consisted of cellulase from Trichoderma viride and hemicellulase from Aspergillus niger in a ratio of 10.5:6, respectively; non-depolymerase BSA from 0-24 mg; and glyphosate from 0-0.3 mg. Following treatment, the seedlings were maintained under good growing conditions. Herbicidal effect was assessed 12 days after treatment (DAT). Percent control ratings ascertained the extent of control, i.e. reduction in growth, and were scored on a basis of 0 to 100 where 100 represents complete killing of the plants and 0 represents no reduction in growth as compared to the untreated control. Table 1 shows the effects of adding BSA to the enzyme and herbicide treatments.

The results of this experiment clearly show the utility of adding bovine serum albumin, a non-depolymerase protein, to enhancing the herbicidal effect of depolymerase, glyphosate, or non-depolymerase protein with glyphosate.

TABLE 1
Percent Control 12 DAT

| Enz | Gly | BSA (mg) | | | |
|---|---|---|---|---|---|
| (mg) | (mg) | 0 | 0.24 | 2.4 | 24 |
| 0 | 0 | 0 | 3 | 7 | 13 |
| 0.16 | 0 | 22 | 20 | 22 | 28 |
| 1.6 | 0 | 33 | 30 | 36 | 60 |
| 0 | 0.003 | 0 | 8 | 10 | 13 |
| 0.16 | 0.003 | 3 | 4 | 10 | 90 |
| 1.6 | 0.003 | 43 | 48 | 86 | 86 |
| 0 | 0.03 | 28 | 33 | 23 | 28 |
| 0.16 | 0.03 | 55 | 52 | 86 | 100 |
| 1.6 | 0.03 | 85 | 92 | 98 | 100 |
| 0 | 0.3 | 28 | 27 | 68 | 73 |
| 0.16 | 0.3 | 68 | 66 | 84 | 94 |
| 1.6 | 0.3 | 98 | 96 | 96 | 96 |

| | | | | |
|---|---|---|---|---|
| Average | 38 | 40 | 51 | 65 |

### Example 2

In one example, a tree stump is prevented from resprouting by disrupting the cambium and latent buds with a liquid composition of depolymerase and non-depolymerase protein applied directly to the surface of the tree stump. The composition contains laccase and superoxide dismutase both derived from the termite Reticulnermes flavipes but expressed recombinantly in a heterologous expression system, cellulases from Trichoderma reesei, and hemicellulases from Aspergillus niger. The enzymes are applied at 0.0001% to 10% of the dry weight of the volume of the material from the outer bark layers through the cambium. By disrupting the cambium and latent buds, the stump is unable to sprout or, if sprouts do form, unable to support continued growth causing them to die. The result is an effective bioherbicide method for naturally preventing tree stump resprouting.

### Example 3

In another example, 1 inch diameter holes are drilled into a tree stump spaced every 4 inches on center and filled with liquid cellulases from Trichoderma reesei, hemicellulases from Aspergillus niger, laccase from Reticulnermes flavipes, and superoxide dismutase from Reticulnermes flavipes in a ratio of 4000:100:1:8 on a unit protein basis, respectively, and slow-drip bottles are placed above the holes. In several weeks, the base of the stump has weakened sufficiently that the stump can be removed with a pickaxe as compared to a stump that has not been treated.

### Example 4

In another example, shredded tree leaves are mixed with cellulases from Trichoderma reesei, hemicellulases from Aspergillus niger, and liquid catalase from Saccharomycese cerevisiae in a ratio of 4000:100:1 on a unit mass protein basis, respectively, and enough water to form a mash in a container. The mash is mixed every other day for several weeks to encourage contact with enzymes. A useful soil amendment or compost is achieved in a few weeks as compared to months for compost piles untreated with depolymerase and non-depolymerase protein.

### Example 4

In another example, ½ inch diameter holes are drilled ½ inch into living trees in a ring every 1 inches of circumference. A liquid mixture is prepared of cellulases from Trichoderma reesei, hemicellulases from Aspergillus niger, and liquid catalase from Saccharyomyces cerevisiae in a ratio of 4000:100:1 on a unit mass protein basis, respectively, and combined with glyphosate to a final concentration of 50 g/L of enzyme and 100 g/L of glyphosate and 1.5 mL of the mixture is injected into each hole. For comparison, the recommended dosage of glyphosate alone for stem injection under the same conditions is 500 g/L. As a result of contact with the solution described above, the growth of the living trees will slow or stop, which is desired in the culling of forests for silviculture (Kochenderfer, Kochenderfer, & Miller, Manual herbicide application methods for managing vegetation in Appalachian hardwood forests, 2011). Thus an equivalent toxic effect on the trees was achieved using a much lower dose of glyphosate, by inclusion of the mixture of depolymerase and non-depolymerase protein.

### Example 5

In another example, a liquid mixture is prepared of cellulases from Trichoderma reesei, hemicellulases from Aspergillus niger, and liquid catalase from Saccharyomyces cerevisiae in a ratio of 4000:100:1 on a unit mass protein basis, respectively. This mixture is applied to the trunk of an apple tree a few days after pruning branches from the trunk and covered with a plastic wrap. The enzyme mixture degrades the tender green adventitious shoots just as they are emerging from the latent buds thus limiting or obviating the need for future pruning.

What is claimed is:

1. A composition used to achieve vegetation degradation, comprising:
a depolymerase derived from a first organism; and
a non-depolymerase protein from a different second organism.

2. The composition of claim 1, wherein the depolymerase is selected from the group:
cellulases, hemicellulases, ligninases, polysaccharidases, pectinases, esterases, proteases.

3. The composition of claim 1, wherein all or a portion of the composition is derived from a microorganism, insect, animal, or plant.

4. The composition of claim 3, wherein a portion of the composition is derived from Trichoderma reesei.

5. The composition of claim 3, wherein all or a portion of the composition is derived from a xylophagous organism.

6. The composition of claim 5, wherein a portion of the composition is derived from the termite Reticulitermes flavipes.

7. The composition of claim 1, wherein the non-depolymerase protein is selected from the group: non-polymer-degrading enzyme, amino acid, peptide, polypeptide, protein, or protein hydrolysate.

8. The composition of claim 1, wherein one or more of the components of the composition is expressed in one or more recombinant expression vectors.

9. The composition of claim 1, wherein the ratio of depolymerase to non-depolymerase protein can be from about 0.001:1 to 100,000:1.

10. The composition of claim 1, wherein the composition further comprises a bioactive agent.

11. The composition of claim 10, wherein the bioactive agent is a biocide.

12. The composition of claim 1, wherein the composition further comprises an agricultural additive.

13. The composition of claim 1, in one or more of the following forms: flowable, dry flowable, water dispersible granule, injectable, emulsified concentrate, film, aerosol, spray, substrate, or gel.

14. A method of achieving vegetation degradation, comprising contacting vegetation or lignocellulosic material with composition comprising a depolymerase and a non-depolymerase protein.

15. The method of claim 14, wherein the composition comprises a depolymerase derived from a first organism and a non-depolymerase protein derived from a second different organism.

16. The method of claim 14, wherein the vegetation or lignocellulosic material is also subjected to drilling, wedging, shoveling, axing, grinding, chopping, smashing, pulverizing, or cutting.

17. The method of claim 14, wherein the composition is applied or inserted into holes or cavities in the vegetation or lignocellulosic material.

18. The method of claim 14, wherein the composition is applied to a tree or tree stump.

19. The method of claim 14, wherein the composition is applied through a slow or continuous drip system.

20. A method of increasing the activity of a bioactive agent, comprising applying a composition including a depolymerase and a non-depolymerase protein together with the bioactive agent to a target vegetation.
